(19) United States
(12) Patent Application Publication
(10) Pub. No.: US 2004/0111246 A1
(43) Pub. Date: Jun. 10, 2004

(54) Fluid flow modeling system with device interchanging capability

(76) Inventor: Morgan Williams, Reseda, CA (US)

Correspondence Address: Jeffrey J. Chapp, Artz & Artz, P.C., Suite 250, 28333 Telegraph Road, Southfield, MI, 48034, US

(21) Appl. No.: 10/315,483

(22) Filed: Dec. 9, 2002

(51) Int. Cl. G06G 7/48

(52) U.S. Cl. 703/9

(57) ABSTRACT

A method of simulating fluid flow through a system (10) having a plurality of devices (52). The method includes generating a plurality of device models (60), each model (60) corresponding to a respective device (52) of the system (10). A set of device models is selected from the plurality of device models (60). Linking information is generated for the set of device models. A fluid flow model is formed for each device (52) having a device model (60) within the set of device models. Fluid flow models are linked utilizing the linking information to form a first fluid flow aggregate system model. Fluid flow through the first fluid flow aggregate system model is simulated.

### TECHNICAL FIELD

The present invention relates generally to fluid flow model simulation techniques, and more particularly, to a system and method of interchanging, coupling, and simulating operational fluid flow through multiple devices.

### BACKGROUND OF THE INVENTION

Numerical fluid flow simulations are often used for performance assessment of fluid devices, such as water pumps, injector manifolds, and other various devices. Thus, three-dimensional (3-D) fluid flow dynamics is used to represent fluid flow through the fluid devices. Simulation of fluid flow on a 3-D numerical lattice grid can reduce design cycle time and manufacturing costs during development of a product.

Two-dimensional and 3-D Navier-Stokes numerical equations are commonly used to represent fluid flow through complex fluid machines that contain different parts and devices. In being complex the machines have corresponding complicated discretized geometries, fluid flow characteristics, and boundary conditions that can be time-consuming to set-up and process in a simulator.

Conventional numerical simulation approaches require that the modeled system be represented by a single flow grid. The flow grid represents discretized geometry surface and volume nodes where flow equations are numerically enforced. Conventional numerical simulation approaches also require that boundary conditions be entered into a simulator for an entire system including boundary conditions of each device that make-up the system, which may be referred to as a single coupled model assembly. Boundary conditions identify location of the boundary flow node, the type of boundary (e.g., moving wall), and the values of specified flow variables (e.g., velocity, temperature). In other words, the separate fluid devices are entered as a single aggregate model representing the system of interest.

Characteristics of individual devices within a system, such as boundary conditions and nodes are typically entered in a preprocessing phase that includes discretizing the surfaces of the system of interest, constructing a volume mesh or grid from the surfaces, merging the volume grid and boundary conditions into a single file, and entering data. After the preprocessing phase, calculations are performed using the Navier-Stokes equations followed by generation of 3-D fluid flow simulation results, which are viewed on a monitor.

In order for the simulation to operate, boundary conditions and any other device characteristics for each device have to be consistent with a single aggregate volume flow grid structure of a total system model. When the device characteristics are consistent with the grid structure the devices are in proper alignment and orientation to allow for calculations to be performed.

When a desire exists to modify a system and to simulate fluid flow through the modified system, for example by replacing an impeller within a pump with an updated impeller, unfortunately, the aggregate volume flow grid has to be reconstructed in a consistent manner and all device characteristics need to be reentered into the simulator for each device within the pump to simulate the new system having the entered modifications. Each device may have thousands of boundary conditions and nodes. Therefore, there is a large amount of time lost in reentering original devices let alone in entering the replacement device. To replace or modify a single device can be costly due to the time involved therein.

It is therefore desirable to provide a fluid flow simulation system that allows for relatively quick and easy interchanging of devices within a system and fluid flow simulation thereof without the need for reentering of device characteristics relative to a single flow grid node numbering system.

### SUMMARY OF THE INVENTION

The present invention provides a system and method of interchanging, coupling, and simulating operational fluid flow through multiple devices. A method of simulating fluid flow through a system having a plurality of devices is provided. The method includes generating a plurality of device models, each model corresponding to a respective device of the system. A set of device models is selected from the plurality of device models. Linking information is generated for the set of device models. A fluid flow model is formed for each device having a device model within the set of device models. Fluid flow models are linked utilizing the linking information to form a first fluid flow aggregate system model. Fluid flow through the first fluid flow aggregate system model is simulated.

The present invention has several advantages over existing numerical fluid flow simulation devices. One advantage is that it allows for interchanging of devices within a system after simulation of the system without requiring reentry of device baseline characteristics of remaining or reused devices. In so doing the present invention decreases time and costs involved in design and manufacturing of a component. The present invention separates a complex system into manageable sub-systems or devices for ease of interchanging and modifying of devices.

Another advantage of the present invention is that it is versatile in that it provides a quick and easy simulation tool for designing and analyzing of various fluid flow devices for a variety of applications.

Furthermore, the present invention provides a system for simulating fluid flow through one or more devices individually and then interchanging these devices within a system to compare performance thereof.

Moreover, the present invention provides time histories of fluid equation solutions and fluid node variables that may be compared between interchanged devices for increased ease in system evaluation and design.

The present invention itself, together with further objects and attendant advantages, will be best understood by reference to the following detailed description, taken in conjunction with the accompanying drawing.

### BRIEF DESCRIPTION OF THE DRAWINGS

FIG. 1 is a block diagrammatic view of a fluid flow simulation system in accordance with an embodiment of the present invention;

FIG. 2 is a logic flow diagram illustrating a method of simulating fluid flow through a system having a plurality of devices in accordance with an embodiment of the present invention;

FIG. 3A is a perspective of an inducer having a device model and coupled to form a pump in accordance with an embodiment of the present invention;

FIG. 3B is a perspective of an impeller having a device model and coupled to form a pump in accordance with an embodiment of the present invention;

FIG. 3C is a perspective of a diffuser having a device model and coupled to form a pump in accordance with an embodiment of the present invention; and

FIG. 3D is a perspective of an aggregate system model of a pump formed by coupling the device models of FIGS. 3A-3C in accordance with an embodiment of the present invention.

### DETAILED DESCRIPTION OF THE PREFERRED EMBODIMENT

In each of the following figures, the same reference numerals are used to refer to the same components. While the present invention is described with respect to a system and method of interchanging, coupling, and simulating operational fluid flow through multiple devices, the present invention may be adapted for various applications including automotive, marine, aerospace, and other applications known in the art. The present invention may be applied to manifolds, pumps, injectors, fluid flow circuits, or to other fluid flow applications known in the art. The fluid flow applications may be gaseous or liquidus in nature.

In the following description, various operating parameters and components are described for one constructed embodiment. These specific parameters and components are included as examples and are not meant to be limiting.

Also, in the following description the term “device” refers to any component or group of components that may be incorporated into a system. A device for example may be a feedpipe of an injector manifold or an impeller of a pump.

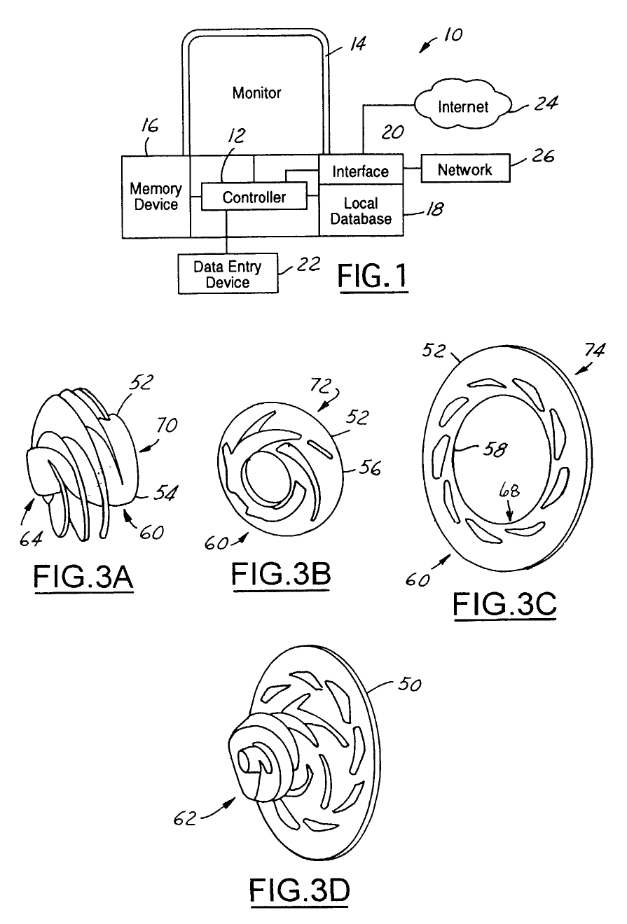

Referring now to FIG. 1, a block diagrammatic view of a fluid flow simulation system 10 in accordance with an embodiment of the present invention is shown. The system 10 includes a controller 12 that is preferably microprocessor based. The controller 12 controls operation of the system 10 and operation of a monitor 14, a memory device 16, a local database 18, and an interface 20. Although, the memory device 16 and the local database 18 are illustrated as separate components, these components may be combined into a single memory and may be in the form of RAM and/or ROM. The memory device 16 may be utilized for performing immediate tasks whereas the local database 18 may be used for storing information over a longer period of time. A data entry device 22 is coupled to the controller 12.

The system 10 may be in the form of a computer, as shown, or may be in the form of a main frame, a workstation, or other operating system known in the art.

The controller 12 may be coupled to an Internet 24 or a network 26 via the interface 20. The controller 12 may access various devices having respective device models at some remote location other than that contained within the memory 16 or the local database 18 using the interface 20.

The local database 18 may include various entries and be formatted into directories as will be further described below. The entries may include device geometries, device boundary conditions, nodes, or other entries known in the art. Boundary conditions may include type of flow variable treatment for nodes on device surfaces, as well as other boundary information known in the art.

The data entry device 22 may be one of a various number of data entry devices such as a keyboard, a mouse, a touch screen, or other device used in computer applications.

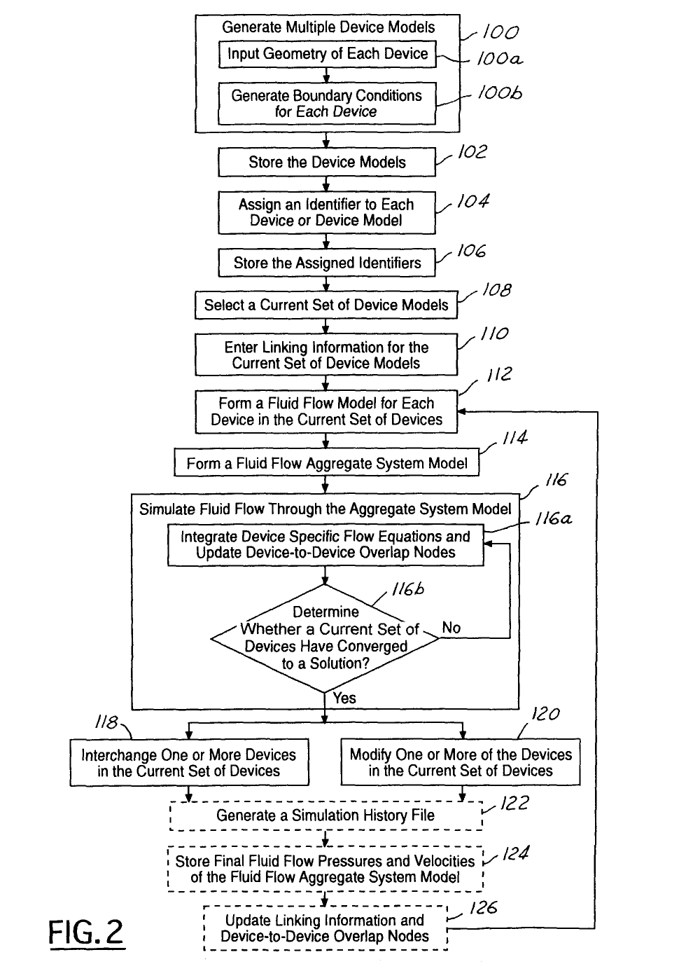

Referring now to FIGS. 2-3, a logic flow diagram illustrating a method of simulating fluid flow through an aggregate system 50 and perspective views of the system 50 and of devices 52 within the system 50 in accordance with an embodiment of the present invention are shown. The system 50 is a pump having three distinct components an inducer 54, an impeller 56, and a diffuser 58, FIGS. 3a-3c respectively, and is shown for example purposes only. The system 50 is shown in aggregate in FIG. 3d.

In step 100, the controller 12 generates multiple device models 60. Although, three device models are shown and number of device models may be generated. Each device model 60 corresponds to one or more of the devices 52. The controller 12 generates a finite-difference model of each device 52. A finite-difference model refers to a lattice of flow nodes where numerical flow equations are enforced by approximating flow variables and derivatives at discrete points. Flow nodes are generated from a surface and volume discretization of device geometry. Flow nodes are discrete points in or on the device geometry where the flow equations are numerically enforced.

In step 100a, in generating the device models 60, geometry of each device 52 may be inputted by a system operator via the data entry device 22 or may be inputted via the interface 20. During entry of device geometry, flow node coordinates are also entered including coordinates of each discrete point in a device 52. The discrete points may be individually entered or may be determined via the controller 12.

In step 100b, boundary conditions are either entered via the entry device 22 or generated by the controller 12 for each of the devices 52. The boundary conditions may include those as stated above and may also include information as how to treat each flow node. Boundary conditions or boundary nodes can be treated differently depending on “type” and physics that they approximate. For example, inlet nodes specify that certain specified flow velocities are to be applied at the stated nodes. Likewise, no-slip flow nodes specify nodes where flow velocities are zero.

In step 102, the device models 60 are stored in designated model directories. In one embodiment of the present invention each device model 60 is stored in a separate directory within the local database 18.

In step 104, the controller 12 or the system operator assigns an identifier, such as a name or identification number to each device 52 or device model 60 for use below in generating an aggregate system model 62.

In step 106, the identifiers associated with each device 52 or device model 60 are stored in a designated identifier file and directory.

In step 108, a current set of device models, or in effect a current set of devices, are selected from the device models 52 entered in step 100. The controller 12 may select the set of device models or the system operator may select the set of device models via the data entry device 22 using the assigned identifiers.

In step 110, the system operator enters linking information for the current set of device models. The linking information may be stored in a designated linking file and directory and be in the form of a two-line specifier. The linking information includes information such as direct coupling of devices 52 and the manner as to which they are coupled together. For example, using the same example from above, the inducer 54, the impeller 56, and the diffuser 58 have respective inlets 64, 66, and 68 and outlets 70, 72, and 74. The outlet 70 of the inducer 54 is directly coupled to the inlet 66 of the impeller 56 and similarly the outlet 72 of the impeller 56 is directly coupled to the inlet 68 of the diffuser 58. The linking information may also include information as to how inlets and outlets are coupled, such as relative positioning, coordinates of overlap flow nodes, relative orientations, and other coupling information known in the art. The term “overlap flow nodes” refers to Cartesian coordinates of a first device that overlap coordinates of a second device at the interface of the two devices.

In step 112, the controller 12 reads from the appropriate device model directories to form a fluid flow model of each device 52 or in effect build each device that is in the current set of devices. A fluid flow model consists of a grid file that contains device surface and volume geometry coordinates where the flow equations are enforced and an input file that contains boundary condition information that specifies flow data for surface nodes. The Navier-Stokes fluid flow equations are utilized in forming the fluid flow models. The Navier-Stokes based equations may be 3-D or 2-D. As known in the art, the Navier-Stokes equations aid in determining fluid flow and performance characteristics of a device. The equations are solved using the boundary conditions and flow nodes of each device.

In step 114, the controller 12 links the fluid flow models utilizing the linking information to form a fluid flow aggregate system model using the assigned identifiers. The fluid flow aggregate system model includes the geometry of the aggregate system model, boundary conditions, and flow nodes for each device therein.

In step 116, the controller 12 simulates fluid flow through the fluid flow aggregate system model, which may be viewed on the monitor 14. In simulating fluid flow through the aggregate system model, as in step 112, the controller 12 again may utilize the Navier-Stokes equations for each individual device together with device-to-device overlap nodes. In step 116a, in one embodiment of the present invention the controller 12 integrates device specific flow equations one numerical time step at a time and updates device-to-device overlap nodes.

In step 116b, the controller 12 determines whether each device 52 in the current set of devices has numerically converged to a flow equation solution. When the devices 52 are not completely converged, as determined by using a suitable convergence tolerance, the controller 12 returns to step 116a, otherwise step 118 is performed.

In step 118, the system operator or the controller 12 may select to interchange one or more devices 52 in the current set of devices with other devices to create an updated set of device models. The controller 12 then proceeds to step 122. Note the present invention in allowing for easy interchanging of devices, in effect provides a technique for “snapping” devices in and out of an aggregate system model.

In step 120, the system operator or controller 12 may modify one or more device models 60 in the current set of device models to also generate an updated set of device models. Note that changes to a device model are local to that device model and not to the entire aggregate model, as in the prior art.

In step 122, the controller 12 may generate a simulation history file including flow equations and overlap node updates for the fluid flow aggregate system model.

In step 124, the controller 12 may store final fluid flow pressures and velocities of the fluid flow aggregate system model in a designated file and directory. Final fluid flow pressure and velocity profiles may be plotted and compared.

In step 126, linking information for the fluid flow models of the updated set of device models may be updated including updating device-to-device overlap nodes. Following step 126 the controller 12 may return to step 112 and use the updated set of device models as the current set of device models.

The above-described steps in the above methods are meant to be an illustrative example, the steps may be performed sequentially, synchronously, continuously, or in a different order depending upon the application.

The present invention provides a system and method of simulating fluid flow through a system having a plurality of devices that allows for easy and quick modification and interchanging of individual devices within a system without reentry and building of the complete system. The present invention decreases time and costs involved in design and evaluation of various systems.

The above-described apparatus and method, to one skilled in the art, is capable of being adapted for various applications and systems known in the art. The above-described invention can also be varied without deviating from the true scope of the invention.

What is claimed is:

1. A method of simulating fluid flow through a system having a plurality of devices comprising:
generating a plurality of device models, each model corresponding to a respective device of the system;
selecting a first set of device models of said plurality of device models;
generating linking information for said first set of device models;
forming a fluid flow model of each device having a device model within said first set of device models;
linking said fluid flow models utilizing said linking information to form a first fluid flow aggregate system model; and
simulating fluid flow through said first fluid flow aggregate system model.

2. A method as in claim 1 wherein generating a plurality of device models comprises generating a plurality of finite-difference models.

3. A method as in claim 1 wherein generating a plurality of device models comprises:
inputting geometry for each device of the plurality of devices; and
generating boundary conditions for each of the plurality of devices.

4. A system as in claim 3 wherein inputting geometry of each of the plurality of devices comprises inputting a plurality of nodes.

5. A method as in claim 1 further comprising storing said plurality of device models in a designated location.

6. A method as in claim 1 further comprising:
assigning an identifier to each device model of said plurality of device models; and
generating said first fluid flow aggregate model using said assigned identifiers.

7. A method as in claim 6 wherein said assigned identifiers are associated with said first set of device models and are stored in a designated location.

8. A method as in claim 1 wherein forming said fluid flow models comprises performing a plurality of fluid flow equations.

9. A method as in claim 1 wherein forming said first fluid flow aggregate model comprises performing a plurality of fluid flow equations.

10. A method as in claim 8 or 9 wherein performing a plurality of fluid flow equations comprises using Navier-Stokes based fluid flow equations.

11. A method as in claim 1 wherein forming said fluid flow models is performed before forming said first fluid flow aggregate model.

12. A method as in claim 1 further comprising:
interchanging at least one device model in said first set of device models with at least one other device model to create a second set of device models of said plurality of device models;
generating linking information for said second set of device models;
forming a fluid flow model of each device having a device model within said second set of device models;
linking said fluid flow models for said second set of device models utilizing said linking information for said second set of device models to form a second system fluid flow model; and
simulating fluid flow through said second system fluid flow model.

13. A system as in claim 12 wherein linking said fluid flow models for said second set of device models comprises updating device-to- device overlap nodes.

14. A system as in claim 1 further comprising:
modifying a device model within said plurality of device models to generate a second set of device models;
generating linking information for said second set of device models;
forming a fluid flow model of each device having a device model within said second set of device models;
linking said fluid flow models for said second set of device models utilizing said linking information for said second set of device models to form a second system fluid flow model; and
simulating fluid flow through said second system fluid flow model.

15. A system as in claim 1 wherein simulating fluid flow through said first fluid flow aggregate system model comprises integrating device specific flow equations one numerical time step at a time. A fluid flow simulation system comprising:
a monitor displaying fluid flow through a fluid flow aggregate system model;
a memory device storing a plurality of device models and linking information; and
a controller electrically coupled to said monitor, said data entry device, and said memory device and generating a device model for each device, forming a fluid flow model for each device having a device model in a set of device models, linking said fluid flow models utilizing said linking information to form a fluid flow aggregate system model, and simulating fluid flow through said fluid flow aggregate system model.

16. A system as in claim 16 wherein said controller generates said linking information.

17. A system as in claim 16 further comprising a data entry device for selecting said set of device models.

18. A system as in claim 16 further comprising a data entry device for entry of said linking information.

19. A system as in claim 16 wherein said controller generates a simulation history file comprising flow equation variable updates and overlap node updates.

20. A system as in claim 16 wherein said controller stores final fluid pressures and velocities of said fluid flow aggregate system model.

21. A method of simulating fluid flow through a system having a plurality of devices comprising:
generating a plurality of device models, each model corresponding to a respective device of the system comprising;
inputting geometry for each device of the plurality of devices; and
generating boundary conditions for each of the plurality of devices;
assigning an identifier to each device model of said plurality of device models;
selecting a set of device models of said plurality of device models;
generating linking information for said set of device models using said assigned identifiers;
forming a fluid flow model of each device within said set of device models;
linking said fluid flow models utilizing said linking information to form a fluid flow aggregate system model; and
simulating fluid flow through said fluid flow aggregate system model.
